(19) United States
(12) Patent Application Publication
(10) Pub. No.: US 2022/0019921 A1
(43) Pub. Date: Jan. 20, 2022

(54) ELECTRONIC DEVICE FOR INCREMENTAL LOSSLESS SUMMARIZATION OF MASSIVE GRAPH AND OPERATING METHOD THEREOF

(71) Applicant: Korea Advanced Institute Of Science And Technology, Daejeon (KR)

(72) Inventors: Kijung SHIN, Daejeon (KR); Jihoon KO, Daejeon (KR); Yunbum KOOK, Daejeon (KR)

(21) Appl. No.: 17/154,544

(22) Filed: Jan. 21, 2021

(30) Foreign Application Priority Data
Jul. 15, 2020 (KR) 10-2020-0087574

(51) Int. Cl. G06N 7/00; G06K 9/62

(52) U.S. Cl. CPC G06N 7/005; G06K 9/6218

(57) ABSTRACT

Various embodiments may provide an electronic device for incremental lossless summarization of a dynamic massive graph and an operating method thereof. In the electronic device and the operating method thereof according to various embodiments, a summary graph created from a massive graph and the differences between the massive graph and the summary graph may be stored, a changed edge may be detected from the massive graph, changed nodes connected by the changed edge may be detected based on the changed edge, and the summary graph and the edge corrections may be updated based on each of the changed nodes.

### BACKGROUND OF THE INVENTION

### Field of the Invention

Various embodiments relate to an electronic device for incremental lossless summarization of a massive graph and an operating method thereof.

### Related Art

A graph is a data structure that represents objects and the connections between them, which may express various and numerous data. Representative examples of the graph include an online social network (connection between users), the World Wide Web (connection between webpages), a purchase history on e-commerce (connection between a customer and a product), a deep learning model (connections between neurons), and so on. With the recent rise of the big data era, large-scale graph data is emerging. For example, the World Wide Web is connecting 5.5 billions of webpages, and a particular social network is connecting 2.4 billions of users.

Such massive data exceeds the capacity of main memory or cache memory of a computer, making analysis difficult. This is because most graph analysis algorithms assume that an entire graph is stored in main memory. A solution to this problem is to compress graph data so that it is stored in main memory.

### SUMMARY OF THE INVENTION

Various embodiments provide an electronic device for incremental lossless summarization of a dynamic massive graph and an operating method thereof.

Various embodiments provide an electronic device for incremental lossless summarization of a massive graph and an operating method thereof.

There is provided an operating method of an electronic device according to various embodiments including the steps of: storing a summary graph created from a massive graph and the differences between the massive graph and the summary graph; detecting a changed edge from the massive graph; detecting changed nodes connected by the changed edge based on the changed edge; and updating the summary graph and the edge corrections based on each of the changed nodes.

There is provided a computer program according to various embodiments, which is coupled to a computer device and stored in a recording medium readable by the computer device, for executing the steps of: storing a summary graph created from a massive graph and the differences between the massive graph and the summary graph; detecting a changed edge from the massive graph; detecting changed nodes connected by the changed edge based on the changed edge; and updating the summary graph and the edge corrections based on each of the changed nodes.

There is provided an electronic device according to various embodiments including the steps of: a memory; and a processor connected to the memory and configured to execute at least one instruction stored in the memory, wherein the processor is configured to store a summary graph created from a massive graph and the differences between the massive graph and the summary graph, detect a changed edge from the massive graph, detect changed nodes connected by the changed edge based on the changed edge, and update the summary graph and the edge corrections based on each of the changed nodes.

According to various embodiments, the electronic device may efficiently remanage a summary graph created from a massive graph and edge corrections according to a lossless graph summarization technique. That is, the electronic device is capable of incremental lossless summarization of a dynamic massive graph. Specifically, the electronic device may update a summary graph created from a massive graph and edge corrections, without summarizing the massive graph again, each time a change is made to the massive graph. Accordingly, the electronic device may update the summary graph and the edge corrections in a time-efficient manner, in spite of changes in the massive graph.

### BRIEF DESCRIPTION OF THE DRAWINGS

FIG. 1 is a view illustrating a lossless graph summarization technique according to various embodiments.

FIG. 2 is a view illustrating an incremental lossless graph summarization technique according to various embodiments.

FIGS. 3 and 4 are views showing algorithms for incremental lossless summarization according to various embodiments.

FIG. 5 is a view illustrating an electronic device according to various embodiments.

FIG. 6 is a view illustrating an operating method of an electronic device according to various embodiments.

FIG. 7 is a view illustrating the step of updating a summary graph and edge correction shown in FIG. 6.

FIG. 8 is a view illustrating the step of deciding a supernode for a testing node shown in FIG. 7.

### DESCRIPTION OF EXEMPLARY EMBODIMENTS

Hereinafter, various embodiments of the present disclosure will be described with reference to the accompanying drawings.

An electronic device for incremental lossless summarization of a dynamic massive graph and an operating method thereof according to various embodiments may summarize a massive graph according to a lossless graph summarization technique. The lossless graph summarization technique is a technique for compressing a plurality of nodes detected from a massive graph and edges connecting the nodes into a summary graph consisting of at least one supernode and at least one superedge connecting the supernodes and edge corrections representing the differences between the massive graph and the summary graph. A supernode comprises a set containing at least one node, and a superedge is taken from one supernode and inserted, and connects two supernodes, and the presence of a superedge may represent that edges are present between all nodes. Such a lossless graph summarization technique aims to summarize the massive graph, while minimizing the size of the summary graph, especially relative to the number of superedges and the size of the edge corrections. According to the lossless graph summarization technique, the original massive graph may be recovered by using the summary graph and the edge corrections together.

According to various embodiments, information on nodes adjacent to a particular node may be obtained correctly and rapidly. Thus, most of the existing graph algorithms such as PageRank and Dijkstra's algorithm may be used as they are. Also, since the summary graph takes the form of a graph, the storage space of the graph may be reduced additionally by using an existing graph compression method.

According to various embodiments, an electronic device and an operating method thereof may provide a technique for incremental lossless summarization of a dynamic massive graph by which data is updated in real time. The technique for incremental summarization of a graph may represent a graph summarization technique in which an empty graph evolves with edges being added or deleted one by one with time. The incremental lossless summarization technique allows for corrections only on updated portions, as opposed to the existing batch algorithms which are inefficient because graph summarization needs to be performed again from the beginning when obtaining a summary after updating the graph. As compared to performing graph summarization again from the beginning by using a state-of-the-art batch algorithm, updating with the incremental lossless summarization technique may be up to 10 million times faster.

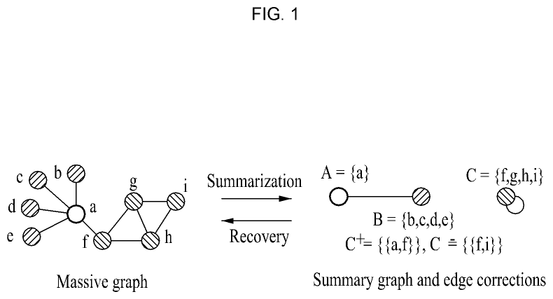

FIG. 1 is a view illustrating a lossless graph summarization technique according to various embodiments.

Referring to FIG. 1, notations and concepts used in various embodiments may be defined.

A graph G=(V, E) represents a massive graph consisting of a set V of nodes and a set E of edges, and may be an undirected graph. Each edge {u,v}∈E is an unordered pair of distinct nodes u,v∈V. The neighborhood of a node u (i.e., the set of nodes adjacent to u) is denoted as N(u)⊂V, and the degree of u is defined as |N(u)|.

A graph G*=(S, P) represents a summary graph of a graph G=(V, E), and may consist of a set S of supernodes and a set P of superedges. A supernode Su contains a node u and the superedge between two supernodes Su, Sv∈S may be expressed as {Su, Sv}∈P.

Given a summary graph G*=(S, P) of a graph G=(V, E), a graph Ĝ=(v, Ė) may be obtained by connecting every pair of nodes between two neighboring supemodes, i.e., {u,v}∈E if and only if u*v and {Su, Sv}∈P. It can be said that G* roughly describes G if Ĝ is similar to G. Moreover, with edge corrections C=(C⁺, C⁻) where C⁺:=E−\hat{B} and C⁻:=\hat{B}−E, the original graph G=(V, E) is exactly recovered from G* as follows in [Mathematical Formula 1]. That is, G* and C losslessly summarize G. Given G, the lossless summarization problem is to find the most concise G* and C.

V←∪_{S}_{ₐ}_{∈S}Sₐ, E←(É∪C⁺)†C⁻.[Mathematical Formula 1]

A fully dynamic graph stream is defined by a sequence {eₜ}ₜ₌₀^{co} of edge changes. Each edge change eₜ may contain an edge addition eₜ={u,v}⁺ and/or an edge deletion eₜ={u,v}⁻. For each edge addition eₜ={u,v}⁺, u and/or v may be new nodes unseen until the current time t. A sequence of edge additions and deletions may be expressive enough to represent a dynamic graph with new and deleted nodes.

An empty graph G₀=ø evolves according to {eₜ}ₜ₌₀^{co}. The graph at time t may be defined by Gₜ=(Vₜ, Eₜ), where Vt and Et are obtained in the inductive way: (1) addition: if eₜ₋₁={u,v}⁺, then Eₜ=Eₜ₋₁∪{{u,v}} and Vₜ=Vₜ₋₁∪{u,v}, (2) deletion: if eₜ₋₁={u−v}⁻, then Eₜ=Eₜ₋₁ †{{u,v}} and Vₜ=Vₜ₋₁. Hereinafter, it is assumed that {u,v} ∉Eₜ₋₁ for every edge addition and {u,v}∈Eₜ₋₁ for every edge deletion. That is, it is assumed that the graph stream is sound.

Given a fully dynamic graph Gₜ evolving under {e^{t}}ₜ₌₀^{co}, the most concise summary graph Gₜ* and edge corrections Cₜ change in response to each change eₜ. Thus, an incremental update to obtain a summary graph G+ and edge corrections Cₜ₊₁ in response to each change eₜ is highly desirable. Thus, we formulate a new problem, namely incremental lossless graph summarization, in the following [Table 1].

TABLE 1
(Incremental Lossless Graph Summarization).
(1) Given: a fully dynamic graph stream {eₜ}ₜ₌₀^{∞}
(2) Retain: a summary graph (Gₜ*= (Sₜ, Pₜ) and edge corrections Cₜ = (Cₜ⁺, Cₜ⁻) of
graph Gₜ at current time t
(3) To Minimize: the size of output representation, i.e.,

φ(t) := |Pₜ| + |Cₜ⁺| + |Cₜ⁻| (1)

Accordingly, the objective function φ(t) of the incremental lossless summarization technique minimizes the sum of the size of the summary graph Gₜ*, especially relative to the number of superedges, and the size of the edge corrections Cₜ, in response to each edge change eₜ, and updates the summary graph and the edge corrections. In φ(t), the number of supemodes, which is marginal compared to that of superedges, is disregarded for simplicity.

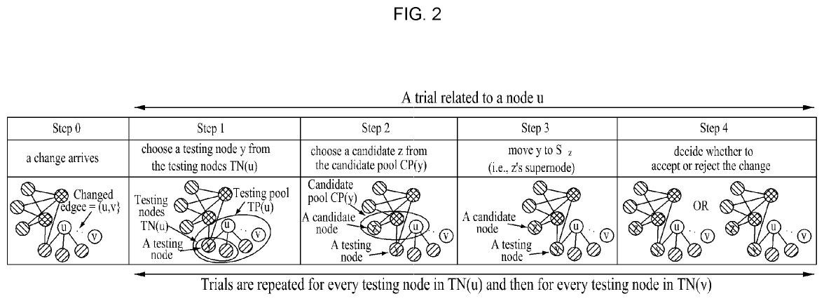

FIG. 2 is a view illustrating an incremental lossless graph summarization technique according to various embodiments.

Referring to FIG. 2, a changed edge {u,v} is given. More precisely, a changed edge {u,v} is given as an edge {u,v} is inserted or deleted at current time t (i.e., eₜ={u,v}⁺ or {u,v}⁻). Here, changed nodes u and v are identified based on the changed edge {u,v}. In response to this, trials related to the changed nodes u and v are performed in the steps 1, 2, 3, and 4. The trials related to the nodes u and v are proceeded on a certain node x, which are the attempt to change the supermode membership Sx of the certain node x. In this case, the trial related to the next changed node v is proceeded after the trial related to the changed node u is finished.

Specifically, a testing node y is chosen from a testing pool TP(u). The testing pool TP(u) is the set of nodes on which a trial related to a changed node u can be proceeded, and may be expressed as the set of all testing nodes at current time t (TN(u)⊆TP(u)). In the step 2, a candidate node z is chosen from a candidate pool CP(y)⊆V. The candidate node z is a node in the supemode into which the testing node y tries moving. Note that this move can be rejected and reverted. A candidate pool CP(y)⊆V is a set of all possible candidate nodes z given to the testing node y. Afterwards, in the step 3, the testing node y is moved to the supemode Sz of the candidate node z. In the step 4, it is determined whether to accept or reject the move, based on the objective function q, that is, the size of the summary graph and edge corrections. That is, it is determined whether to maintain the move or return. In this case, trials related to a changed node u are repeated for every testing node in the testing pool TP(u).

While finding the optimal set S of supemodes, which minimizes the objective function φ, is challenging, finding the optimal set P of superedges and edge corrections C for the current set S of supemodes is straightforward. For each supemode pair {A, B}, let E_{AB}:={{u,v}∈E|u∈A, v∈B, u≠v} and T_{AB}:={{u,v}⊆V|u∈A, v∈B, u≠v} be the sets of existing and potential edges between the supemodes A and B, respectively. Then, the edges E_{AB} between the supemodes A and B are optimally encoded as follows in [Table 2]:

TABLE 2
Optimal encoding for the edges in E_{AB}:
$( 1 ) If \vert {E}_{AB} \vert \leq \frac{\vert {T}_{AB} \vert + 1}{2} ,$
then add all edges in E_{AB} to the edge corrections C⁺.
$( 2 ) If \vert {E}_{AB} \vert > \frac{\vert {T}_{AB} \vert + 1}{2} ,$
then add the superedge {A, B} to the set P of superedges
and T_{AB}\E_{AB} to the edge corrections C⁻.

Note that adding all edges in E_{AB} to the edge corrections C⁺ increases the objective function φ by |E_{AB}|, while adding the superedge {A, B} to the set P of superedges and T_{AB}†E_{AB} to C⁻ increases the objective function φ by 1+|T_{AB}|′−|E_{AB}|.

MoSSo-Greedy may be presented as a baseline streaming algorithm related to the [Table 1]. According to MoSSo-Greedy, when an edge {u,v} is inserted or deleted, MoSSoGreedy greedily moves u and then v, while fixing the other nodes, so that the objective function e is minimized. That is, in terms of the introduced notions, MoSSo-Greedy sets TP(u)=TN(u)={u}, and a candidate is chosen from CP(y)=V so that φ is minimized.

However, MoSSo-Greeey is disadvantageous in that, while |TN(u)| is just 1, unlike the other algorithms described below, this approach is computationally expensive as it takes all supemodes into account to find a locally best candidate. It is also likely to get stuck in a local optimum, as described below. Accordingly, Limitation 1 (Obstructive Obsession) is that MoSSo-Greedy lacks exploration for reorganizing supemodes, and thus nodes tend to stay in supemodes that they move into in an early stage. This stagnation also prevents new nodes from moving into existing supemodes. These lead to poor compression rates in the long run.

Meanwhile, MoSSo-MCMC may be presented as another streaming baseline algorithm based on randomized search. According to MoSSo-MCMC, it significantly reduces the computational cost of each trial, compared to MoSSo-Greedy, since it does not have to find the best candidate, and thus makes more trials affordable. Moreover, its randomness helps escaping from local optima and smoothly coping with changing optima. Randomized searches based on Markov Chain Monte Carlo (MCMC) have proved effective for the inference of stochastic block models. We focus on an interesting relation between communities in SBM and supemodes in graph summarization. Since nodes belonging to the same community are likely to have similar connectivity, grouping them into a supemode may achieve significant reduction in φ. In response to each change {u,v}⁺ or {u,v}⁻, MoSSo-MCMC performs the following steps for u as in the following [Table 3], and then the exactly same steps for v. In Step (1), the neighbors of u, that is, adjacent nodes, are used as testing nodes since they are affected most by the input change. The deg(u) trials can be afforded since a trial in MoSSo-MCMC is computationally cheaper than that in MoSSo-Greedy.

TABLE 3
Trials related to u by MoSSo-MCMC:
(1) Set TN(u) = TP(u) = N(u).
(2) For each y in TN(u), select a candidate node z from CP(y) = V through sampling
according to a predefined proposal probability distribution.
(3) For each y, accept the proposal (i.e., move y into Sz) with an acceptance
probability, which depends on the change in φ.

However, MoSSo-MCMC suffers from two limitations, which are the bottlenecks of its speed and compression rates. Accordingly, Limitation 2 (Costly Neighborhood Retrievals) is that, to process each change {u,v}⁺ or {u,v}⁻ in the input stream, MoSSo-MCMC retrieves the neighborhood of many nodes from current G* and C. Specifically, it retrieves the neighborhood of u in Step (1), and for each testing node y, it retrieves the neighborhood of at least one node to select a candidate in Step (2). That is, at least 2+|TN(u)|+|TN(v)|=2+deg(u)+deg(v) neighborhood retrievals occur. Thus, the time complexity of MoSSo-MCMC is deadly affected by growth of graphs, which may lead to the appearance of high-degree nodes and the increase of average degree. Limitation 3 (Redundant Tests) is that, for proposals to be accepted, promising candidates leading to reduction in φ need to be sampled from the proposal probability distribution. However, the probability distribution, which proved successful for SBM, results in mostly rejected proposals and thus a waste of computational time.

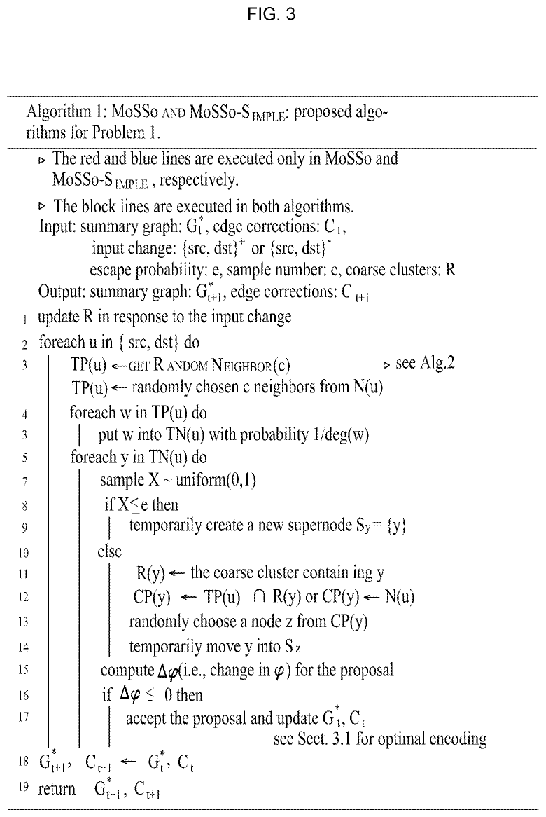

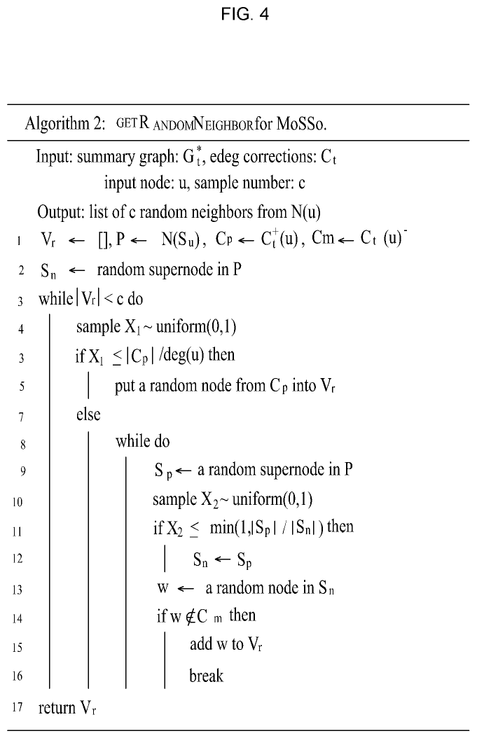

FIGS. 3 and 4 are views showing algorithms for incremental lossless summarization according to various embodiments.

MoSSo-Simple, a preliminary version of MoSSo, may be presented with three novel ideas for addressing the limitations that the baseline streaming algorithms suffer from. MoSSo-Simple may be implemented as in Algorithm 1 illustrated in FIG. 3. In response to each change {u,v}⁻ or {u,v}⁻, MoSSo-Simple conducts the following steps for u as in the following [Table 4] and then exactly the same steps for v.

TABLE 4
Trials related to u by MoSSo-Simple:
(1) Sample a fixed number (denoted by c) of nodes from N(u) and
use them as TP(u).
(2) Add each w ∈ TP(u) to TN(u) with probability
$\frac{1}{deg ( w )} .$
(3) For each y ∈ TN(u), with probability e of escape, propose creating
a singleton supernode {y}.
(4) Otherwise, randomly select a candidate node z from CP(y) where
CP(y) = N(u) for every y ∈ TN(u).
(5) For each y, accept the proposal (i.e., move y to Sz) if and only
if it reduces φ.

Contrary to MoSSo-MCMC, for each change {u,v}⁻ or {u,v}⁻, MoSSo-Simple (1) extracts TN(u) from TP(u) probabilistically depending the degrees of nodes, and (2) limits CP(y) to N(u) for every testing node y∈TP(u). These ideas enable MoSSo-Simple to significantly outperform MoSSo-MCMC, as well as MoSSo-Greedy, in terms of speed and compression rates. MoSSo-Simple may have the following three ideas.

The first idea is Careful Selection. When forming TN(u), MoSSo-Simple first samples a fixed number of nodes from N(u) and constructs TP(u) using them. Then, it adds each sampled node w∈TP(u) to TN(u) with probability 1/deg(w). In practice, high-degree nodes tend to have unique connectivity, and thus they tend to form singleton supemodes. Therefore, moving them rarely leads to the reduction of q. However, high-degree nodes are frequently contained in TP(u) since edge changes adjacent to any neighbor u put the high-degree nodes into TP(u). Moreover, once they are chosen as testing nodes, computing the change in e and updating the optimal encoding are computationally expensive since they have many neighbors. By probabilistically filtering out high-degree nodes when forming TN(u), MoSSo-Simple significantly reduces redundant and computationally expensive trials and thus partially addresses Limitation 3 (i.e., Redundant Tests).

The second idea is Corrective Escape. Instead of always finding a candidate from CP(y), it separates y from the supemode Sy and creates a singleton supemode {y} with probability e∈[0, 1). By injecting flexibility to the formation of a summary graph, this idea, which we call Corrective Escape, helps supemodes to be reorganized in different and potentially better ways in the long run. Therefore, this idea addresses Limitation 1 and yields significant improvement in compression rates.

The third idea is Fast Random. By limiting CP(y) to N(u) for every testing node y∈TN(u), MoSSo-Simple reduces the number of required neighborhood retrievals and thus partially addresses Limitation 2 (i.e., Costly Neighborhood Retrievals). For each input change, while MoSSo-MCMC repeats neighborhood retrievals 2+deg(u)+deg(v) times, MoSSo-Simple only retrieves N(u) and N(v). Moreover, since N(u) still contains promising candidates, limiting CP(y) to N(u) does not impair the compression rates.

Although the above ideas successfully mitigate the limitations, there remain issues to be resolved. In relation to Limitation 2 (Costly Neighborhood Retrievals), while MoSSo-Simple reduces the number of neighborhood retrievals to two per each input change, the retrievals still remain as a scalability bottleneck. Retrieving the neighborhood of a node from current G* and C takes O(d̅e̅g̅) time on average, where

$$\overline{deg} = \frac{2 \vert E \vert}{\vert V \vert}$$

the average degree in the input graph. However, it is well known that lots of real-world graphs are densified over time. Specifically, the number of edges increases super-linearly in the number of nodes, leading to the growth of d̅e̅g̅ over time. Hence, full neighborhood retrievals pose a huge threat to scalability. Moreover, in relation to Limitation 3 (Redundant Tests), while MoSSo-Simple uses the degree of nodes to reduce redundant trials, it does not fully make use of structural information around input nodes but simply draws a random candidate from N(u). Careful selection of candidates based on the structural information can be desirable to further reduce the number of redundant trials and thus to achieve concise summarization rapidly.

To overcome the aforementioned drawbacks of MoSSo-Simple, MoSSo may be presented. MoSSo employs (1) coarse clustering for careful candidate selection and (2) getRandomNeighbor, a novel sampling method, instead of full neighborhood retrievals. Equipped with these ideas, MoSSo achieves near-constant processing time per change and compression rates even comparable to state-of-the-art batch algorithms. A pseudo code of MoSSo may be provided in Algorithm 1 illustrated in FIG. 3. In response to each change {u,v}⁻ or {u,v}⁻, MoSSo conducts the following steps for u as in the following [Table 5] and then exactly the same steps for v.

TABLE 5
Trials related to u by MoSSo:
(1) Update coarse clusters in response to the change.
(2) Sample a fixed number (denoted by c) of nodes from N(u), without
retrieving all N(u), and use them as TP(u).
(3) Add each w ∈ TP(u) to TN(u) with probability
$\frac{1}{deg ( w )} .$
(4) For each y ∈ TN(u), with probability e of escape, propose creating
a singleton supernode {y}.
(5) Otherwise, randomly select a candidate node z from CP(y) where
CP(y) = TP(u)∩R(y) and R(y) is the coarse cluster containing y.
(6) For each y, accept the proposal (i.e., move y to Sz) if and only if it
reduces φ.

The gist of MoSSo consists of two parts: (1) rapidly and uniformly sampling neighbors from N(u) without retrieving the entire N(u) from G* and C and (2) using an online coarse clustering to narrow down CP(y). MoSSo may have the following two ideas.

The first idea is Fast Random. As explained in Limitation 2, for scalability, it is inevitable to devise a neighborhood sampling method less affected by the average degree, which tends to increase over time. Thus, we come up with getRandomNeighbor, described in Algorithm 2 illustrated in FIG. 4. It is an MCMC method for rapidly sampling nodes from N(u) in an unbiased manner without retrieving the entire N(u). After obtaining a sufficient number of neighbors by getRandomNeighbor, MoSSo limits TP(u) to the sampled neighbors.

Assume that the neighborhood in C⁺, C⁻, and P of each node is stored in a hash table, and let N(Su):={Sv∈S |{Su, Sv}∈P} be the set of neighboring supemodes of a supemode Su. Then, v∈N(u) can be checked rapidly as follows in [Table 6].

TABLE 6

Checking v ∈ N(u) on G* and C:
(1) If v ∈ C⁻(u), then v ∉ N(u).
(2) Else if v ∈ C⁺(u)or Sv ∈ N(Su), then v ∈ N(u).
(3) Else v ∉ N(u).

The neighbors of u are divided into two disjoint sets: (1) those in C⁺(u) and (2) those in any supemode in N(Su). Then, we can uniformly sample a neighbor of u by uniformly sampling a node either from the first set (with probability

$$\frac{\vert {C}^{+} ( u ) \vert}{deg ( u )} )$$

or from the second set (with probabili

$$1 - \frac{\vert {C}^{+} ( u ) \vert}{deg ( u )} ) .$$

Since the first set is already materialized, uniform sampling from it is straightforward. The remaining challenge is to uniformly sample a node from the second set without materializing the second set. This challenge is formulated in the following [Table 7], where N(Su) is denoted by {S₁, . . . , Sₖ}).

TABLE 7
We have k disjoint supemodes S1, . . . Sk with Nᵢ := N(u)∩Sᵢ for each i. For
large k, it is computationally expensive to obtain ∪ᵢ₌₁^{k} Nᵢ. However, we can rapidly
check whether a given node is contained in ∪ᵢ₌₁^{k} Nᵢ. How can we rapidly and
uniformly draw nodes from ∪ᵢ₌₁^{k} Nᵢ?
Our solution: Instead of uniform sampling from ∪ᵢ₌₁^{k} Nᵢ, getRandomNeighbor,
described in Algorithm 2 illustrated in FIG. 4, samples a node from ∪ᵢ₌₁^{k} Sᵢand
retries sampling if the node is not in ∪ᵢ₌₁^{k} Nᵢ. To this end, it randomly selects a
supernode Si with probability
π(Sᵢ is selected) := |Sᵢ|/(S₁| + . . . + |Sₖ|) (2),
and then draws a random node from the selected supemode. If the node is not in
∪ᵢ₌₁^{k} Nᵢ, then this procedure is repeated again from beginning. It is guaranteed that
this sampling scheme draws each node in ∪ᵢ₌₁^{k} Nᵢ uniformly with probability 1/N,
where N := Σᵢ₌₁^{k} |Nᵢ|.

In the above solution, when sampling supemodes according to Equation (2) of the above [Table 7], it is desirable to avoid computing |Si| for every i∈{1, . . . , k}, since k can be large, as formulated in the following [Table 8].

TABLE 8
How to sample supernodes according to Equation (2) without
computing |Si| for each i?
Our solution: getRandomNeighbor employs MCMC, which basically
constructs a Markov chain asymptotically equal to Equation (2).
Specifically, a supemode Sp is proposed uniformly at random among k
supernodes, and then it replaces a previously sampled supernode,
which is denoted by Sn, with the following acceptance probability:
$min ( 1 , \frac{π ( {S}_{p} is selected ) }{π ( {S}_{n} is selected )} ) = min ( 1 , \frac{\vert {S}_{p} \vert}{\vert {S}_{n} \vert} ) .$

Both solutions are combined in Algorithm 2 illustrated in FIG. 4, which describes the entire process for sampling c neighbors from N(u).

The second idea is Careful Selection. To choose candidates leading to a significant reduction in φ, MoSSo uses coarse clusters, each of which consists of nodes with similar connectivity. Specifically, in MoSSo, the candidate pool CP(y) of each testing node y consists only of nodes belonging to the same duster of y. The coarse dusters are distinct from supemodes, which can be thought as fine clusters.

Any incremental graph clustering methods can be used for coarse clustering. A representative example of these methods is min-hashing. The probability that two nodes belong to the same duster is proportional to the jaccard similarity of their neighborhoods. Moreover, dusters grouped by min-hashing can be updated rapidly in response to changes.

By employing the above ideas, MoSSo processes each change in near-constant time and shows outstanding compression.

Various embodiments may provide an electronic device for incremental lossless summarization of a massive graph and an operating method thereof. The various embodiments may be implemented based on the above-described MoSSo-Simple or MoSSo. That is, an electronic device for incremental lossless summarization of a massive graph and an operating method thereof according to various embodiments may be related to the algorithms illustrated in FIGS. 3 and 4.

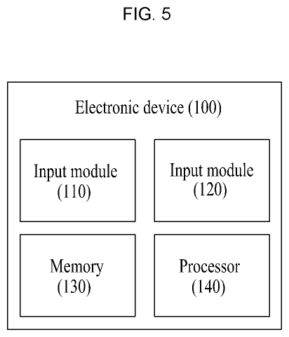

FIG. 5 is a view illustrating an electronic device 100 according to various embodiments.

Referring to FIG. 5, the electronic device 100 according various embodiments may comprise at least one of an input module 110, an output module 120, a memory 130, and a processor 140. In some embodiments, at least one of the elements of the electronic device 100 may be omitted, or at least one or more other elements may be added to the electronic device 100. In some embodiments, at least two of the elements of the electronic device 100 may be implemented as a single integrated circuit.

The input module 110 may receive a signal to be used for at least one element of the electronic device 100. The input module 110 may include at least one of an input device configured for a user to give a signal input directly into the electronic device 100, a sensor device configured to detect a change in the surroundings and generate a signal, and a receiving device configured to receive a signal from an external device. For example, the input device may include at least one of a microphone, a mouse, and a keyboard. In some embodiments, the input device may include at least one of a touch circuitry configured to sense a touch, and a sensor circuitry configured to measure the strength of force generated by the touch.

The output module 120 may provided information to the outside of the electronic device 100. The output module 120 may include at least one of a display device configure to visually output information, an audio output device for outputting information as an audio signal, and a transmitting device for wirelessly transmitting information. The display device may include, for example, at least one of a display, a hologram device, and a projector. In an example, the display device may be assembled with at least one of the touch circuitry and sensor circuitry of the input module 110 and implemented as a touchscreen. The audio output device may include, for example, at least one of a speaker and a receiver.

In an embodiment, the receiving device and the transmitting device may be implemented as a communication module. The communication module may perform communication between the electronic device 100 and an external device. The communication module may establish a communication channel between the electronic device 100 and an external device. Here, the external device may include at least one of a satellite, a base station, a server, and another electronic device. The communication module may include at least one of a wired communication module and a wireless communication module. The wireless communication module may be connected via wires to an external device and communicate with it via wires. The wireless communication module may include at least one of a short-range communication module or a long-range communication module. The short-range communication module may communicate with an external device by a short-range communication method. The short-range communication method may include, for example, at least one of Bluetooth, WiFi direct, and Infrared data association (IrDA). The long-range communication module may communicate with an external device by a long-range communication method. Here, the long-range communication module may communicate with an external device through a network. The network may include, for example, at least one of a cellular network, the internet, and a computer network such as LAN (local area network) or WAN (wide area network).

The memory 130 may store various data used by at least one element of the electronic device 100. The memory 130 may include, for example, at least one of volatile memory and nonvolatile memory. The data may include at least one program and input data or output data associated with the software. The program may be stored as software in the memory 130, and may include, for example, at least one of an operating system 142, middleware 144, or an application 146.

The processor 140 may execute the program of the memory 130 and control at least one element of the electronic device 100. Through this, the processor 140 may perform data processing or calculation. The processor 140 may execute the instructions stored in the memory 130.

According to various embodiments, the processor 140 may summarize a massive graph according to a lossless graph summarization technique. The lossless graph summarization technique is a technique for compressing a plurality of nodes detected from a massive graph and edges connecting the nodes into a summary graph consisting of at least one supemode and at least one superedge connecting the supemodes and edge corrections representing the differences between the massive graph and the summary graph. The processor 140 may summarize the massive graph, while minimizing the size of the summary graph, especially relative to the number of superedges and the size of the edge corrections. Through this, the processor 140 may store the summary graph and the edge corrections in the memory 130.

According to various embodiments, the processor 140 may update the summary graph and edge corrections for the dynamic massive graph according to an incremental lossless summarization technique. At this point, the processor 140 may update the summary graph and the edge corrections based on the above-described MoSSO-Simple or MoSSO. That is, the processor 140 may operate based on the algorithms illustrated in FIGS. 3 and 4.

The processor 140 may detect a changed edge from the massive graph and detect changed nodes connected by the changed edge based on the changed edge. Here, the changed edge may include at least one of an edge added to the massive graph and an edge deleted from the massive graph. Also, the processor 140 may update the summary graph and the edge corrections based on each of the changed nodes. To this end, the processor 140 may decide whether to change the supemode for at least one adjacent node of each of the changed nodes or not. Accordingly, the processor 140 may update the summary graph and the edge corrections based on a change of the supemode for adjacent nodes.

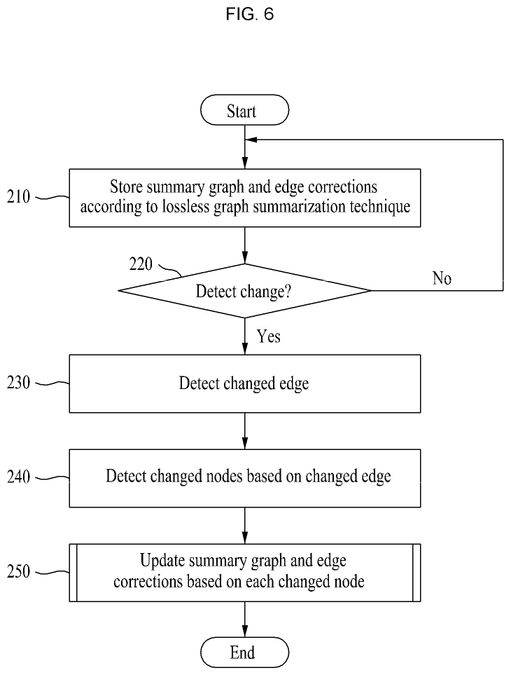

FIG. 6 is a view illustrating an operating method of an electronic device 100 according to various embodiments.

Referring to FIG. 6, the electronic device 100 may store a summary graph and edge corrections according to a lossless graph summarization technique in the step 210. To this end, the processor 140 may store a summary graph and edge corrections according to a lossless graph summarization technique. The lossless graph summarization technique is a technique for compressing a plurality of nodes detected from a massive graph and edges connecting the nodes into a summary graph consisting of at least one supemode and at least one superedge connecting the supemodes and edge corrections representing the differences between the massive graph and the summary graph. The processor 140 may summarize the massive graph, while minimizing the size of the summary graph, especially relative to the number of superedges and the size of the edge corrections. Through this, the processor 140 may store the summary graph and the edge corrections in the memory 130.

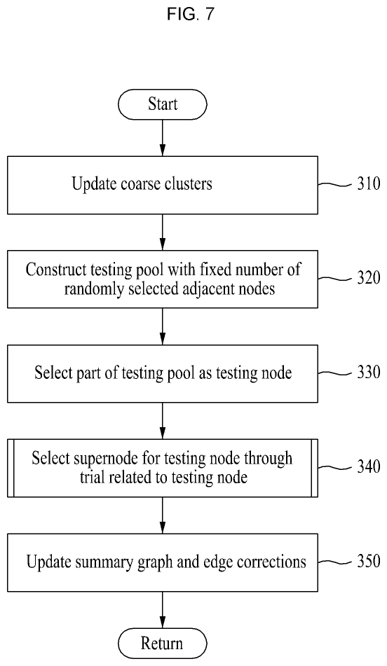

The electronic device 100 may detect a change in the summary graph in the step 220. In response to this, the electronic device 100 may detect a changed edge in the step 230. Here, the change edge may include at least one of an edge added to the massive graph and an edge deleted from the massive graph. Also, the electronic device 100 may detect changed nodes based on the changed edge in the step 240. The processor 140 may detect changed nodes connected by the changed edge. Through this, the electronic device 100 may update the summary graph and the edge corrections based on each changed node in the step 250. At this point, the processor 140 may update the summary graph and the edge corrections based on the above-described MoSSO-Simple or MoSSO. This will be described in more details with reference to FIG. 7.

FIG. 7 is a view illustrating the step of updating a summary graph and edge correction shown in FIG. 6.

Referring to FIG. 7, the electronic device 100 may update coarse clusters in the step 310. The coarse dusters each may consist of nodes with similar connectivity, and distinct from supemodes. The processor 140 may update coarse dusters based on an incremental graph clustering method, for example, min-hashing.

The electronic device 100 may construct a testing pool with a fixed number of randomly selected adjacent nodes which neighbor a changed node in the step 320. The processor 140 may construct a testing pool with a fixed number of adjacent nodes neighboring a changed node, rather than configuring a testing pool with every adjacent node neighboring a changed node. In this case, the processor 140 may randomly select a fixed number of adjacent nodes by using getRandom Neighbor described in Algorithm 2 illustrated in FIG. 4.

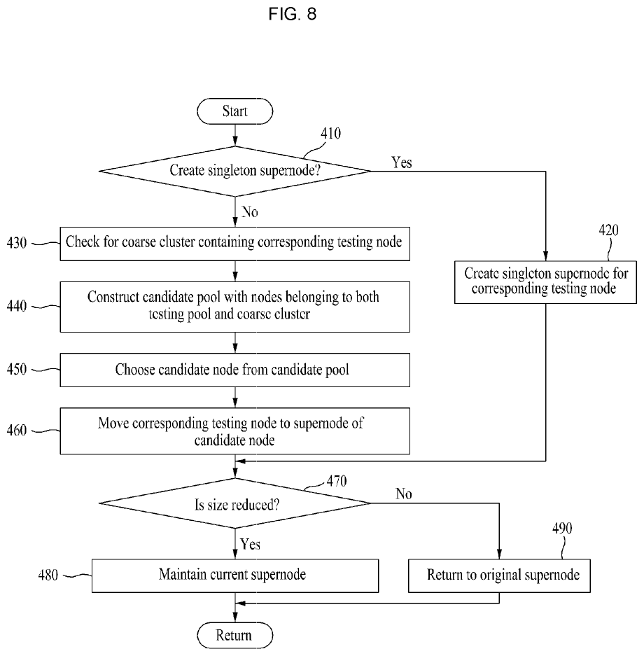

The electronic device 100 may select part of the testing pool as a testing node in the step 330. Also, the electronic device 100 may select a supemode for the testing node through a trial related to the testing node in the step 340. This will be described in more details with reference to FIG. 8. Here, the processor 140 may perform the step 340 on some nodes of the testing pool as testing nodes. Accordingly, the electronic device 100 may update the summary graph and the edge corrections in the step 350.

FIG. 8 is a view illustrating the step of deciding a supemode for a testing node shown in FIG. 7.

Referring to FIG. 8, the electronic device 100 may decide whether to create a singleton supemode for a testing node in the step 410. The processor 140 may decide whether to create a singleton supemode for a corresponding testing node based on the escape probability of the node. Once it is decided that a singleton supemode needs to be created in the step 410, the electronic device 100 may create a singleton supemode for the corresponding testing node in the step 420. Afterwards, the electronic device 100 may proceed to the step 470.

Meanwhile, once it is decided that a singleton supemode does not need to be created in the step 410, the electronic device 100 may check for a coarse duster containing the corresponding testing node in the step 430. The electronic device 100 may construct a candidate pool with nodes belonging to both the testing pool and the coarse duster in the step 440. The electronic device 100 may choose a candidate node from the candidate pool in the step 450. The electronic device 100 may move the corresponding testing node to the supemode of the candidate node in the step 460. Afterwards, the electronic device 100 may proceed to the step 470.

The electronic device 100 may determine whether the size of the summary graph and edge corrections to be updated will be reduced or not in the step 470. In other words, the electronic device 100 may calculate the amount of change caused by the updating of the summary graph and edge corrections for the corresponding testing node. If a singleton supemode is created for the corresponding testing node in the step 420, the processor 140 may calculate the amount of change caused by the updating of the summary graph and edge corrections, based on the creation of a singleton supemode for the corresponding testing node. Meanwhile, if the corresponding testing node is moved to the supemode of the candidate node in the step 460, the processor 140 may calculate the amount of change caused by the updating of the summary graph and edge corrections, based on the movement of the corresponding testing node to the supemode of the candidate node.

Once it is decided that the size will be reduced in the step 470, the electronic device 100 may maintain the current supemode for the corresponding testing node in the step 480. That is, if the amount of change caused by the updating of the summary graph and edge corrections is negative, the electronic device 100 may maintain the current supemode for the corresponding testing node. If a singleton supemode is created for the corresponding testing node in the step 420, the processor 140 may maintain the singleton supemode for the corresponding testing node in the step 480. Meanwhile, if the corresponding testing node is moved to the supemode of the candidate node in the step 460, the processor 140 may maintain the moved supemode for the corresponding testing node in the step 480. Afterwards, the electronic device 100 may return to FIG. 7 and proceed to the step 350.

Once it is decided that the size will not be reduced in the step 470, the electronic device 100 may return to the original supemode for the corresponding testing node in the step 490. That is, if the amount of change caused by the updating of the summary graph and edge corrections is zero or positive, the electronic device 100 may return to the original supemode for the corresponding testing node. If a singleton supemode is created for the corresponding testing node in the step 420, the processor 140 may return to the original supemode for the corresponding testing node in the step 490. Meanwhile, if the corresponding testing node is moved to the supemode of the candidate node in the step 460, the processor 140 may return to the original supemode for the corresponding testing node in the step 490. Afterwards, the electronic device 100 may return to FIG. 7 and proceed to the step 350.

Various embodiments of the present disclosure may be embodied as a computer program containing one or more instructions stored in a storage medium (e.g., memory 130) readable by a computer device (e.g., electronic device 100). For example, a processor (e.g., processor 140) of the computer device may invoke at least one of the one or more instructions stored in the recording medium and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

The computer program according to various embodiments may include storing a summary graph created from a massive graph and the differences between the massive graph and the summary graph, detecting a changed edge from the massive graph, detecting changed nodes connected by the changed edge based on the changed edge, and updating the summary graph and the edge corrections based on each of the changed nodes.

According to various embodiments, the summary graph may consist of at least one supemode and at least one superedge connecting the suppernodes, which are obtained from a plurality of nodes detected from the massive graph and edges connecting the nodes.

According to various embodiments, the changed edge may include at least one of an edge added to the massive graph and an edge deleted from the massive graph.

According to various embodiments, the updating of the massive graph and the edge corrections may include deciding whether to change the supemode for at least one adjacent node of each of the changed nodes or not, and updating the summary graph and the edge corrections based on a change of the supemode for adjacent nodes.

According to various embodiments, the deciding whether to change the supemode for at least one adjacent node of each of the changed nodes or not may include updating coarse clusters, constructing a testing pool with a fixed number of randomly selected adjacent nodes for each of the changed nodes, selecting part of the testing pool as a testing node, and selecting a supemode for the testing node through a trial related to the testing node.

According to various embodiments, the selecting of the supemode for the testing node may include checking for a coarse cluster containing the testing node, constructing a candidate pool with nodes belonging to both the testing pool and the coarse duster, choosing a candidate node from the candidate pool, calculating the amount of change caused by the updating of the summary graph and edge corrections, based on the movement of the testing node to the supemode of the candidate node, and maintaining the moved supemode for the testing node if the amount of change is negative and otherwise returning to the original supemode for the testing node.

According to various embodiments, the selecting of the supemode for the testing node may include calculating the amount of change caused by the updating of the summary graph and edge corrections, based on the creation of a singleton supemode for the testing node, and maintaining the moved supemode for the testing node if the amount of change is negative and otherwise returning to the original supemode for the testing node.

According to various embodiments, the electronic device 100 may efficiently manage a summary graph created from a massive graph and edge corrections according to a lossless graph summarization technique. That is, the electronic device 100 is capable of incremental lossless summarization of a dynamic massive graph. Specifically, the electronic device 100 may update a summary graph created from a massive graph and edge corrections, without summarizing the massive graph again, each time a change is made to the massive graph. Accordingly, the electronic device 100 may update the summary graph and the edge corrections in a time-efficient manner, in spite of changes in the massive graph.

It should be understood that various embodiments of this document and terms used in the embodiments do not limit technology described in this document to a specific embodiment and include various changes, equivalents, and/or replacements of a corresponding embodiment. The same reference numbers are used throughout the drawings to refer to the same or like parts. Unless the context otherwise dearly indicates, words used in the singular include the plural, and the plural includes the singular. In this document, an expression such as “Aor B” and “at least one ofAor/and B”, “A, B or, C” or “at least one of A, B, or/and C” may include all possible combinations of together listed items. An expression such as “first” and “second” used in this document may indicate corresponding components regardless of order or importance, and such an expression is used for distinguishing a component from another component and does not limit corresponding components. When it is described that a component (e.g., a first component) is “(functionally or communicatively) coupled to” or is “connected to” another component (e.g., a second component), it should be understood that the component may be directly connected to the another component or may be connected to the another component through another component (e.g., a third component).

The term “module” used herein may include a unit including hardware, software, or firmware, and, for example, may be interchangeably used with the terms “logic,” “logical block,” “component” or “circuit”. The “module” may be an integrally configured component or a minimum unit for performing one or more functions or a part thereof. For example, the “module” be configured in the form of an Application-Specific Integrated Circuit (ASIC) chip.

According to various embodiments, each component (e.g., a module or a program) of the above-described components may include a single entity or multiple entities. According to various embodiments, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An operating method of an electronic device, the method comprising:
storing a summary graph created from a massive graph and the differences between the massive graph and the summary graph;
detecting a changed edge from the massive graph;
detecting changed nodes connected by the changed edge based on the changed edge; and
updating the summary graph and the edge corrections based on each of the changed nodes.

2. The method of claim 1, wherein the summary graph consists of at least one supernode and at least one superedge connecting the suppernodes, which are obtained from a plurality of nodes detected from the massive graph and edges connecting the nodes.

3. The method of claim 2, wherein the changed edge comprises at least one of an edge added to the massive graph and an edge deleted from the massive graph.

4. The method of claim 2, wherein the updating of the massive graph and the edge corrections comprises:
deciding whether to change the supernode for at least one adjacent node of each of the changed nodes or not; and
updating the summary graph and the edge corrections based on a change of the supemodes for adjacent nodes

5. The method of claim 4, wherein the deciding whether to change the supernode for adjacent nodes comprises:
updating coarse clusters;
constructing a testing pool with a fixed number of randomly selected adjacent nodes for each of the changed nodes,
selecting part of the testing pool as a testing node; and
selecting a supernode for the testing node through a trial related to the testing node.

6. The method of claim 5, wherein the selecting of the supernode for the testing node comprises:
checking for a coarse cluster containing the testing node;
constructing a candidate pool with nodes belonging to both the testing pool and the coarse cluster;
choosing a candidate node from the candidate pool;
calculating the amount of change caused by the updating of the summary graph and edge corrections, based on the movement of the testing node to the supernode of the candidate node; and
maintaining the moved supernode for the testing node if the amount of change is negative and otherwise returning to the original supernode for the testing node.

7. The method of claim 5, wherein the selecting of the supernode for a testing node comprises:
calculating the amount of change caused by the updating of the summary graph and edge corrections, based on the creation of a singleton supernode for the testing node; and
maintaining the moved supernode for the testing node if the amount of change is negative and otherwise returning to the original supernode for the testing node.

8. A computer program coupled to a computer device and stored in a recording medium readable by the computer device, for executing:
storing a summary graph created from a massive graph and the differences between the massive graph and the summary graph;
detecting a changed edge from the massive graph;
detecting changed nodes connected by the changed edge based on the changed edge; and
updating the summary graph and the edge corrections based on each of the changed nodes.

9. The computer program of claim 8, wherein the summary graph consists of at least one supernode and at least one superedge connecting the suppernodes, which are obtained from a plurality of nodes detected from the massive graph and edges connecting the nodes.

10. The computer program of claim 9, wherein the changed edge comprises at least one of an edge added to the massive graph and an edge deleted from the massive graph.

11. The computer program of claim 9, wherein the updating of the massive graph and the edge corrections comprises:
deciding whether to change the supernode for at least one adjacent node of each of the changed nodes or not; and
updating the summary graph and the edge corrections based on a change of the supernodes for adjacent nodes.

12. The computer program of claim 11, wherein the deciding whether to change the supernode for adjacent nodes comprises
updating coarse clusters;
constructing a testing pool with a fixed number of randomly selected adjacent nodes for each of the changed nodes;
selecting part of the testing pool as a testing node; and
selecting a supernode for the testing node through a trial related to the testing node.

13. The computer program of claim 12, wherein the selecting of the supemode for the testing node comprises:
checking for a coarse cluster containing the testing node,
constructing a candidate pool with nodes belonging to both the testing pool and the coarse cluster;
choosing a candidate node from the candidate pool;
calculating the amount of change caused by the updating of the summary graph and edge corrections, based on the movement of the testing node to the supernode of the candidate node; and
maintaining the moved supernode for the testing node if the amount of change is negative and otherwise returning to the original supernode for the testing node.

14. The computer program of claim 12, wherein the selecting the supemode for a testing node comprises:
calculating the amount of change caused by the updating of the summary graph and edge corrections, based on the creation of a singleton supernode for the testing node; and
maintaining the moved supernode for the testing node if the amount of change is negative and otherwise returning to the original supernode for the testing node.

15. An electronic device comprising:
a memory; and
a processor connected to the memory and configured to execute at least one instruction stored in the memory,
wherein the processor is configured to store a summary graph created from a massive graph and the differences between the massive graph and the summary graph, detect a changed edge from the massive graph, detect changed nodes connected by the changed edge based on the changed edge, and update the summary graph and the edge corrections based on each of the changed nodes.

16. The electronic device of claim 15, wherein the summary graph consists of at least one supernode and at least one superedge connecting the suppernodes, which are obtained from a plurality of nodes detected from the massive graph and edges connecting the nodes, and the changed edge comprises at least one of an edge added to the massive graph and an edge deleted from the massive graph.

17. The electronic device of claim 16, wherein the processor is configured to decide whether to change the supernode for at least one adjacent node of each of the changed nodes or not and update the summary graph and the edge corrections based on a change of the supernodes for adjacent nodes

18. The electronic device of claim 17, wherein the processor is configured to update coarse clusters, construct a testing pool with a fixed number of randomly selected adjacent nodes for each of the changed nodes, select part of the testing pool as a testing node, and select a supernode for the testing node through a trial related to the testing node.

19. The electronic device of claim 18, wherein the processor is configured to check for a coarse cluster containing the testing node, construct a candidate pool with nodes belonging to both the testing pool and the coarse cluster, choose a candidate node from the candidate pool, calculate the amount of change caused by the updating of the summary graph and edge corrections, based on the movement of the testing node to the supernode of the candidate node, and maintain the moved supernode for the testing node if the amount of change is negative and otherwise return to the original supernode for the testing node.

20. The computer program of claim 18, wherein the processor is configured to calculate the amount of change caused by the updating of the summary graph and edge corrections, based on the creation of a singleton supernode for the testing node and maintain the moved supernode for the testing node if the amount of change is negative and otherwise return to the original supernode for the testing node.
